(19) United States
(12) Patent Application Publication
(10) Pub. No.: US 2007/0288585 A1
(43) Pub. Date: Dec. 13, 2007

(54) Cluster system

(76) Inventors: Tomoki Sekiguchi, Sagamihara (JP); Koji Amano, Yokohama (JP); Takahiro Ohira, Hitachi (JP)

Correspondence Address: MCDERMOTT WILL & EMERY LLP, 600 13TH STREET, N.W., WASHINGTON, DC, 20005-3096, US

(21) Appl. No.: 11/783,262

(22) Filed: Apr. 6, 2007

(30) Foreign Application Priority Data
May 9, 2006 (JP) 2006-130037

(51) Int. Cl. G06F 15/173

(52) U.S. Cl. 709/209

(57) ABSTRACT

In a cluster that is composed of two computer nodes and has no common storage, mutual aliveness is monitored over networks. However, this is insufficient because a party node may be wrongly determined as inactive. If failover is performed according to wrong determination, the counterpart may be restored to a normal condition after the failover, so that both the two computers may operate as master. The two nodes to constitute the cluster and other computers to communicate with the cluster are connected by switches that can disable ports to which the computers are connected. A network control program that controls the switches changes the legality of use of ports to which the nodes are connected, synchronously with node failover.

### CLAIM OF PRIORITY

The present application claims priority from Japanese Patent Application JP 2006-130037 filed on May 9, 2006, the content of which is hereby incorporated by reference into this application.

### BACKGROUND OF THE INVENTION

(1) Field of the Invention

The present invention relates to a configuration for achieving high availability of a cluster system composed of two computers and a control means thereof. More particularly, it relates to a method for achieving high availability of a cluster system configured to have no external storage shared between two computers.

(2) Description of the Related Art

The concept of a cluster exists as a method for increasing availability of processing performed in a computer system. In a cluster system, identical programs are installed in plural computers, and some of the computers perform actual processing. The remaining computers, when detecting a failure in a computer that is performing processing, perform the processing in place of the failed computer.

General cluster systems are composed of two computers. One of the computers is a computer (master) that performs actual processing, and the other is a computer (slave) that is waiting to take over processing of the master against a failure in the master. The two computers periodically monitor mutual aliveness by communication over a network. Generally, for the slave to take over data during failover from slave to master, a shared external storage accessible to both the two computers is used. The shared storage is used under mutual exclusion so that it can be accessed from only master at that time. The SCSI protocol is commonly available as access means for achieving this.

In a such a cluster, when slave detects system failure in master, the slave switches itself to master. At this time, the slave obtains the right of access to the shared storage before starting the execution of an application. The application refers to data stored in the shared storage to perform processing for takeover, and starts actual processing.

Such a cluster includes software for cluster control and applications executed in coordination with it. An example of software coordinated with the cluster control software is a database management system.

On the other hand, a cluster system has a problem in time necessary for a standby to start execution as master. The above-described cluster system cannot provide service to others between processing for obtaining the right of access to a shared storage and takeover processing in a computer that has become master. Particularly, access right control of the shared storage generally requires several tens of seconds.

In systems that cannot permit service down of several tens of seconds, a cluster system known as a parallel cluster is configured in which a shared storage is not disposed. An example of this is disclosed in Japanese Patent Application Laid-Open No. 2001-109642. In the patent, master processes requests and transmits the results to slave to synchronize processing states between the master and the slave. Like Japanese Patent Application Laid-Open No. 2001-344125, coordination between master and slave is duplicated to increase the reliability of cluster failover. Furthermore, like Japanese Patent Application Laid-Open No. H05-260134, monitoring devices are hierarchized to cope with processing for a failure in the monitoring devices, thereby increasing the reliability of a system.

In some cases, computers of both master and slave receive processing requests and process them. Master computer outputs processing results and the slave internally stores them to provide for switching to master. The both computers communicate with each other and perform processing for requests while synchronizing the progress of the processing.

These methods eliminate the need to take over access right for a shared storage during failover and allow slave to immediately start execution as master. The slave is thus controlled to have the same states as the master to provide for failover all the time, whereby time required for failover from the slave to the master can be shortened and system down time can be reduced.

In a cluster system, it is important that each computer correctly knows the state of the other. A cluster organized to have a shared storage confirms states of a counterpart by using two different shared media, communication over networks and the control of access right for the shared storage. In the parallel cluster, each computer knows the state of the other by network communication via a third party.

### SUMMARY OF THE INVENTION

In the parallel cluster, common media for coordinating two computers of master and slave is only communication over mutual networks. In state monitoring by network communication, it is determined that a counterpart is inactive when communication has been impossible.

However, the computers to constitute the cluster cannot determine from state monitoring alone by network communication that the communication has been impossible due to failure in the counterpart, malfunction in network processing or network equipment in an own line, or trouble in the networks themselves. As a result, a computer in one line may incorrectly determine that the counterpart is inactive due to communication interruption although actually not inactive.

Furthermore, if slave performs failover according to wrong determination when communication is temporarily interrupted for some reason, the counterpart may be restored to a normal condition after the failover, so that both the two computers may operate as master. In this case, the cluster system may disorder external systems.

As one of means for addressing this, a computer determined to be inactive is commanded to stop, or a reset signal or the like is transmitted to forcibly shutdown the computer. With the former method, since a command is sent to a computer considered inactive, it is unknown whether the command can be normally received, so that there is a problem because of the lack of reliability. With the latter method, since a computer is reset, error information of the computer is lost and it becomes difficult to analyze error causes.

Two computers to constitute a parallel cluster (first node, second node), and other computers (e.g., client computers) to communicate with computers of each cluster are connected by one or more network switches that can independently enable or disable ports to which the computers are connected. A cluster control program is connected to these network switches, and a network control program executed in it controls the network switches to disable ports to which a computer being originally master is connected, before cluster control programs executed in the computer to constitute the first node and the computer to constitute the second node switch slave to master. By doing so, the computer of the original master is disconnected from the network.

On the other hand, the cluster control program executed in the computer to constitute each node of the cluster, in coordination with the network control program executed in the cluster control computer, requests the network control program to disconnect the master, before starting failover by the network switches.

In order that the network control program executed in the cluster control computer properly perform control in line with operation modes of cluster nodes, the cluster control programs executed in the computers to constitute the cluster nodes notify the network control program of events such as node activation, transition to master or slave, and node shutdown.

According to the present invention, the configuration of a cluster that is composed of two computers and has no storage shared between the computers for cluster control helps to prevent the both computers from behaving as master as a result of executing failover due to wrong recognition of states of a counterpart.

Situations of aliveness monitoring between the computers to organize the cluster are monitored from outside of the computers and a computer with which communication is determined to be interrupted is isolated from the cluster, thereby preventing both lines from behaving as master and enabling sure transition to master.

Moreover, since a failed computer does not need to be forced to stop, data necessary for error analysis about the computer is not deleted.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing the configuration of a system of a first embodiment of the present invention;

FIG. 2 is a block diagram centering on the configuration of programs that execute a procedure for achieving cluster control in a first embodiment;

FIG. 3 is a processing flowchart showing the first half of a procedure for cluster failover in a first embodiment of the present invention;

FIG. 4 is a processing flowchart showing the latter half of the procedure for cluster failover in a first embodiment of the present invention;

FIGS. 5A and 5B are drawings showing the structure of data managed in cluster control computers in embodiments of the present invention; and

FIG. 6 is a processing flowchart showing a procedure of the monitoring of an internal network in a second embodiment of the present invention.

### DESCRIPTION OF THE PREFERRED EMBODIMENTS

The following will describe embodiments of the present invention with reference to the accompanying drawings.

### First Embodiment

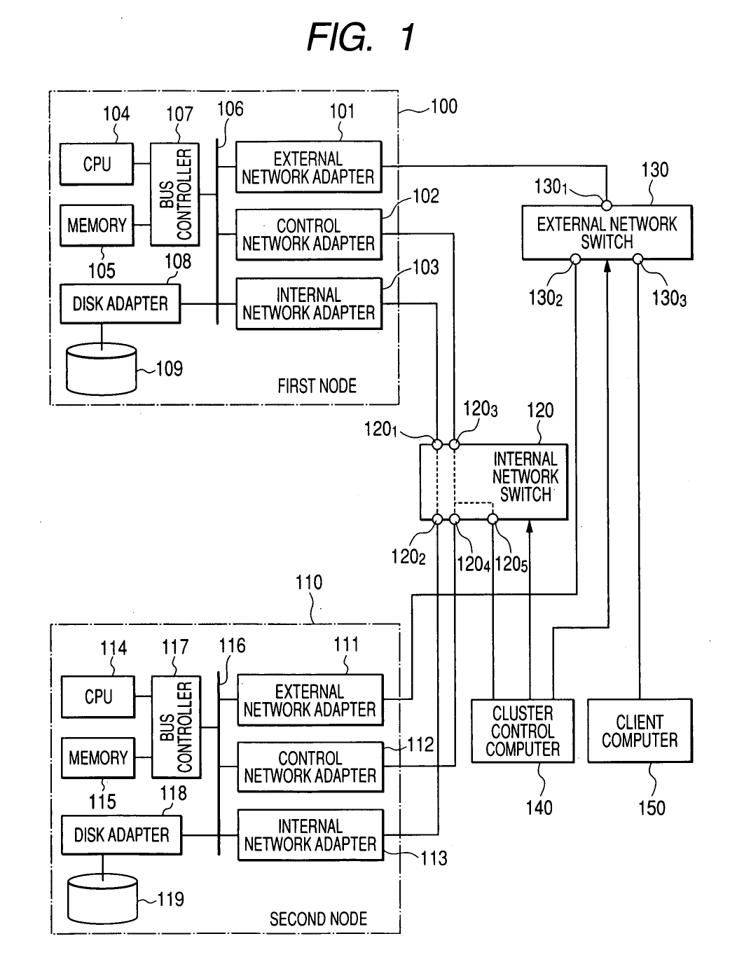

FIG. 1 is a block diagram showing the configuration of a system of a first embodiment of the present invention. A cluster in the present invention includes a computer 100 of a first node and a computer 110 of a second node that constitute the cluster, an internal network switch 120 that forms a communication network between the nodes, a client computer that accesses each of the nodes, an external network switch 130 that forms a communication network between the nodes and the client computer, and a cluster control computer 140 that receives information from each node and executes programs for controlling the enabling or disabling of ports of the network switches.

The computer 100 of the first node and the computer 110 of the second node are normal computers, and respectively include CPUs 104 and 114, memories 105 and 115, bus controllers 107 and 117 that control connection between them and buses 106 and 116, and storage devices 109 and 119 connected to the buses 106 and 116 via disk adapters 108 and 118. These computers respectively include external network adapters 101 and 111 for connecting the buses 106 and 116 and the external network switch 130, control network adapters 102 and 112 for controlling the failover between master and slave of the computers 100 and 110 of the nodes and connecting the computers 100 and 110 of the nodes and the internal network switch 120, and internal network adapters 103 and 113 for evaluating the master and the slave of the computers of the nodes and connecting the computers 100 and 110 of the nodes and the internal network switch 120.

The external network adapters 101 and 111 are connected to the external network switch 130 via the ports 130₁ and 130₂. The client computer 150 is connected to the external network switch 130 via the port 130₃. If the computer 100 of the first node is master, only the ports 130₁ and 130₃ are enabled, and the computer 100 of the first node and the client computer 150 are connected. If the computer 110 of the second node is master, only the ports 130₂ and 130₃ are enabled, and the computer 110 of the second node and the client computer 150 are connected.

The internal network adapters 103 and 113 are connected to the internal network switch 120 via the ports 120₁ and 120₂ to mutually communicate information about states of the computers 100 and 110 of their own nodes.

The control network adapters 102 and 112 are connected to the internal network switch 120 via the ports 120₃ and 120₄. The cluster control computer 140 is connected to the internal network switch 120 via a port 120₅. The control network adapters 102 and 112 mutually interchange information about states of the computers 110 and 100 of other nodes obtained via the internal network adapters 103 and 113, and control messages corresponding to states of the computers 100 and 110 of their own nodes, and at the same time interchange control signals with the cluster control computer 140. The cluster control computer 140, based on collected information, sends an enabling or disabling signal to the ports of the internal network switch 120 and the external network switch 130.

A network formed by the internal network adapter 103 of the computer 100 of the first node and the internal network adapter 113 of the computer 110 of the second node to communicate with each other via the internal network switch 120, and a network formed by the computer 100 of the first node, the computer 110 of the second node, and the cluster control computer 140 to perform communication on control of the cluster via the internal network switch 120 are achieved by the setting of the internal network switch 120.

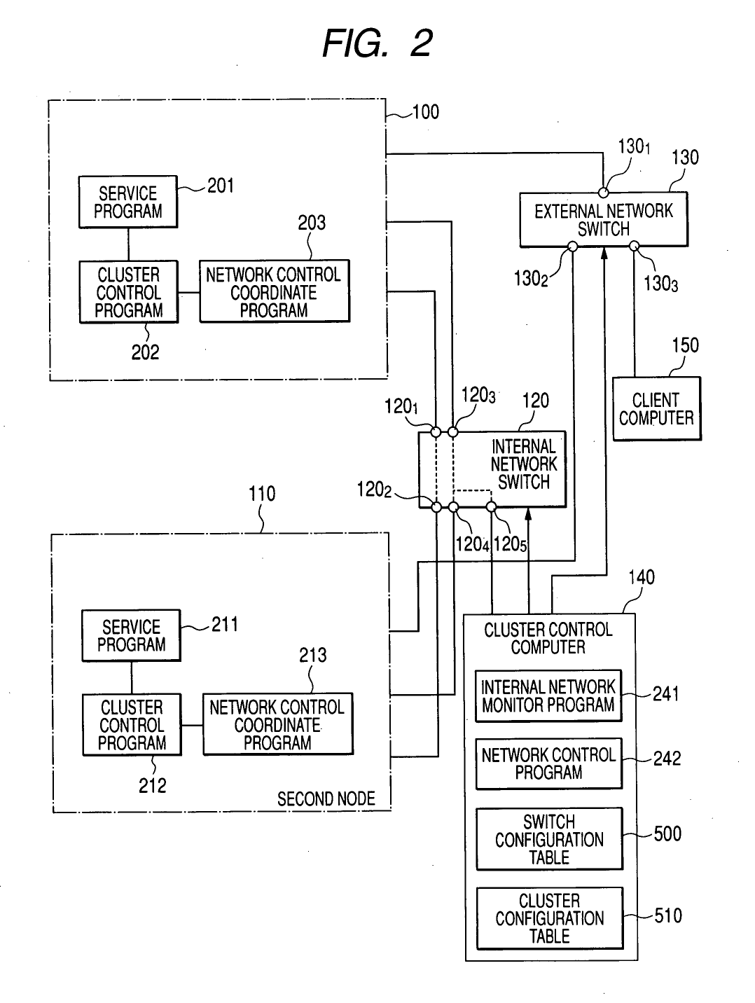

FIG. 2 is a block diagram centering on the configuration of programs that execute a procedure for achieving cluster control in the first embodiment. The respective programs of the computers 100 and 110 of the nodes are stored in the storage devices 108 and 118 of the computers in which they are executed, and during execution, are loaded into memories 105 and 115 for execution by the CPUs 104 and 114 (hereinafter, referred to simply as executing the programs). For the cluster control computer 140, a storage device, a memory, CPU, and adapters corresponding to the internal network adapters 103 and 113, and the external network adapters 101 and 111 are not shown in the drawing. However, it goes without saying that it includes a storage device, a memory, CPU, and adapters, like the computers 100 and 110 of the nodes.

The computers 100 and 111 of the nodes to constitute the cluster include service programs 201 and 211 to provide actual services to the outside of the cluster, that is, the client computer 150, cluster control programs 202 and 212 to control cluster configuration, and network control coordinate program 203 and 213 to report change of node operation modes to the cluster control computer 140.

The cluster control computer 140 includes an internal network monitor program 241 that monitors a network status of connection ports of each cluster of the internal network switch 120, and a network control program 242 that changes the setting of enabling or disabling of connection ports of each cluster of the external network switch 130, and executes them. It also includes a switch configuration table 500 and a cluster configuration table 510 that manage setting data referred to by them. They will be described later.

The following describes the operation of the programs in the first embodiment.

The cluster control programs 202 and 212 of the nodes manage the operation mode of the nodes. The cluster control programs 202 and 212 mutually monitors aliveness of the party node via the internal network switch 120. For example, the cluster control program 202 executed in the computer 100 of the first node, and the cluster control program 212 executed in the computer 110 of the second node mutually send messages successively at a fixed cycle through the port 120₃ of the internal network switch 120 to which the control network adapter 102 is connected, and the port 120₄ to which the control network adapter 112 is connected. The respective cluster control programs 202 and 212 confirm that the messages are received successively at the fixed cycle from the party node. By the mutual communications, the computers 100 and 110 of the nodes mutually monitor operation modes.

An operation mode of the computers of the nodes indicates one of an inactive state in which the cluster control programs 202 and 212 are stopped, a ready state in which the cluster control programs 202 and 212 are executed but the service programs 201 and 212 are not executed, and master state in which the service programs 201 and 212 provide service, and slave state in which the service programs 201 and 212 are executed but output no processing result.

The following describes transition of the operation mode of the computers of the nodes. When a computer of a node is activated, the operation mode transitions from the inactive state to the ready state. Transition from the ready state to the master state or the slave state is usually made by an indication from an operator of the cluster. When a computer of a party mode has become the slave state when the computer of an own node is in the slave state, or when the operation mode of the party node in the master state has become undefined, the cluster control programs 202 and 212 shift the operation mode of the computer of the own node from the slave state to the master state. When a node in the master state and a node in the slave state are interchanged by an indication from the operator, the node in the master state is made to shift to the slave state. By this processing, the cluster control program of the party node in the slave state is executed to detect that the node in the master state has shifted to the slave state.

The service programs 201 and 211 process a service request transmitted from the client computer 150 in coordination with the cluster control programs 202 and 212, via the ports 130₁ and 130₂ of the external network switch to which the external network adapters 101 and 111 are connected, and the port 130₃ to which the client computer 150 is connected. The coordination between the cluster control programs 202 and 212 and the service programs 201 and 211 includes the acquisition of operation modes of the computers 100 and 110 that execute the service programs 201 and 121.

When the operation mode of the computer 100 of the first node is the master state, the service program 201 outputs a processing result of the request. At this time, in the computer 110 of the second node in the slave state, the service program 211, without sending the response to service request to the outside, stores it in the inside of the computer 110, for example, the disk 119. The contents of data stored are data required for output of the response to service request of service request processing by the service program 211 when the computer 110 of the second node has become the master state. The service programs in the master state and the slave state may synchronize the progress of request processing in coordination with each other.

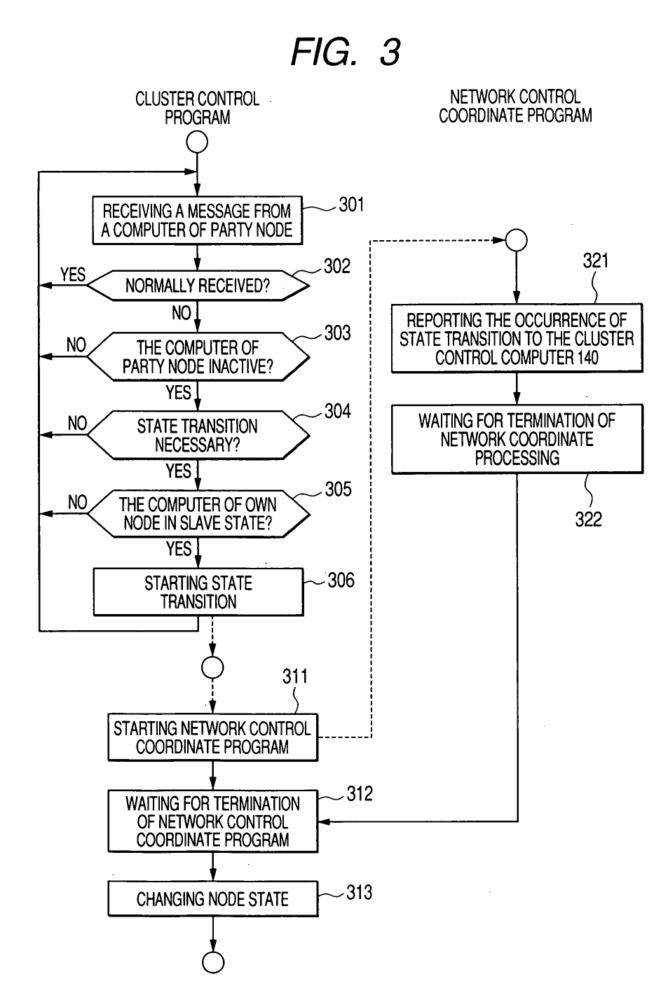

FIG. 3 is a processing flowchart showing the first half of a procedure for cluster failover in the first embodiment of the present invention. With reference to FIG. 3, the following describes the transition of operation modes, centering on the operation of the computer 100.

In the computer 100 of the first node, monitor processing of the cluster control program 202 waits to receive a message outputted at a fixed cycle from the computer 110 of the second node (Step 301). The receive processing fails when a message does not arrive for a predetermined time in the internal network adapter 103 connected to the port 120₁ of the internal network switch 120. When a message is normally received in the internal network adapter 103 (Yes in Step 302), the cluster control program repeatedly waits for a message. When message reception from the computer 110 of the second node fails (No in Step 302), the cluster control program determines whether the computer 110 of the second node stops (Step 303). Although there are various methods for the determination, generally, when a message is unsuccessfully received successively for a predetermined period, the cluster control program determines that the computer 110 of the second node stops. When it cannot be determined that the computer 110 stops, the cluster control program returns to message reception processing (Step 301).

When it is determined in Step 303 that the computer 110 of the second node stops, the cluster control program determines whether operation mode transition (failover) is necessary (Step 304). When it is determined that operation mode transition is necessary, the cluster control program determines whether the operation mode of the computer 100 of the first node is the slave state (Step S305). When the determination is No, that is, when the operation mode of the computer 100 of the first node is the master state, failover processing is not performed. When it is the slave state, the cluster control program performs operation mode transition start processing (Step 306). In this case, Step 306 is processing for starting failover processing.

The above is basic operation of a parallel cluster. The following an additional procedure for achieving the present invention.

Generally, the cluster control programs 202 and 212 executed in the computers 100 and 110 of cluster nodes have an interface for incorporating processing suited for service provided by the computers of the nodes when starting change of the operation mode of computers of the nodes. The present invention assumes this. In the present invention, the interface is used to incorporate the network control coordinate programs 203 and 213. The network control coordinate programs 203 and 213 are executed when the cluster control programs 202 and 212 are started and stop, and when the operation mode of computers of nodes transitions.

The following describes failover processing in the present invention. The operation mode transition start processing (Step 306) in the flowchart shown in FIG. 3 is processing for starting failover processing.

The failover processing is triggered by the operation mode transition start processing (Step 306) and starts the incorporated network control coordinate program 203 (Step 311). The cluster control program passes a current operation mode and a newly set operation mode as parameters to the network control coordinate program 203. After starting the network control coordinate program 203, the failover processing waits for its termination (Step 312). Termination wait processing in Step 312 may time-out at a predetermined time.

The network control coordinate program 203 reports to the network control program 242 executed in the cluster control computer 140 that operation mode transition has been started in the computer 100 of the first node (Step 321), waits for termination of processing (network disconnection processing, that is, invalidating the port 130₁ of the external network switch 130) of the network control program 242 (Step 322), and terminates after the termination of the processing. Termination processing in Step 322 may time-out at a predetermined time.

Upon termination of the coordinate program 203, the failover processing of the cluster control program 202 changes the operation mode of the computer of the node (Step 313).

Start processing and stop processing of the cluster control program 202 also include processing for starting the network control coordinate program 203. These processings are the same as the processing in and after Step 306 of FIG. 3. Specifically, at start time, transition from stop to start occurs, while at stop time, transition from the mode at that time to stop occurs. A processing flow for the transitions is omitted.

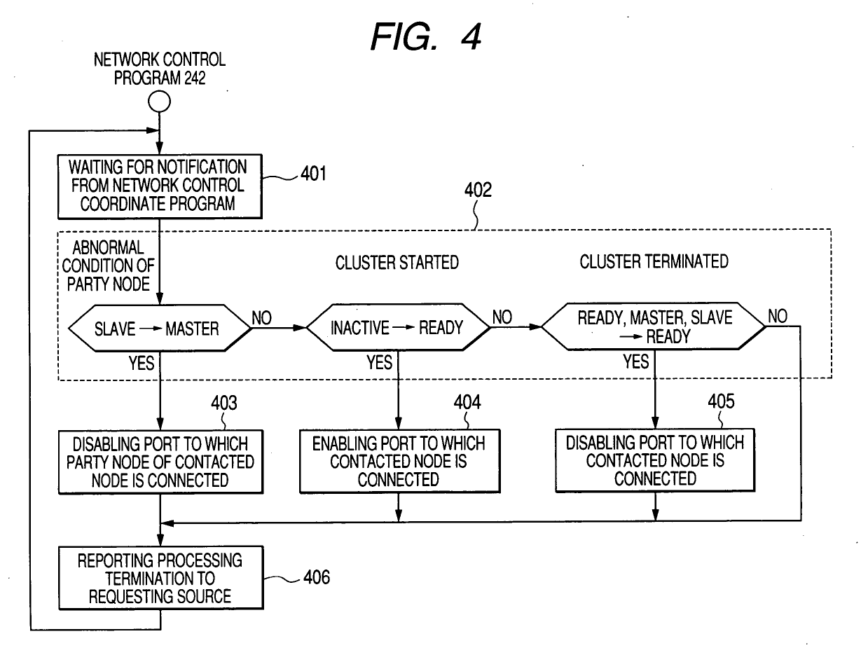

FIG. 4 is a processing flowchart showing the latter half of the procedure for cluster failover in the first embodiment of the present invention. With reference to FIG. 4, a description will be made of a processing flow of the network control program 242 of the cluster control computer 140 that changes the network configuration of the cluster in coordination with transition of the operation modes of the computers of the nodes. The description will be made centering on the operation of the computer 100 of the first node.

The network control program 242 waits for notification of operation mode transition from the computers of the nodes of the cluster (Step 401). The notification of operation mode transition is sent to the internal network switch 120 via the ports 120₃ and 120₄ to which the control network adapter 102 of the computer 100 of the first node and the control network adapter 112 of the computer 110 of the second node are connected, and transmitted to the cluster control computer 140 by the port 120₅ in Step 313.

On reception of the notification of operation mode transition, the network control program 242 branches processing according to the contents of the received transition (Step 402). For example, in the above-described failover processing due to computer abnormality of the party node, the cluster control program 202 of the computer 100 of the first node that determined that the computer 110 of the second node stops changes the operation mode of the computer 100 of the first node from the slave mode to the master mode when the computer 100 is in the slave mode. The network control program 242 shifts processing to Step 403 according to the contents of the transition. Step 403 disconnects the computer 110 of the second node, which is a counterpart of the computer 100 of the first node that sends the notification of operation mode transition, from the internal network switch 120 and the external network switch 130. Specifically, the network control program 242 commands the internal network switch 120 and the external network switch 130 to disable the ports 120₂ and 130₂ to which the internal network adapter 113 and the external network adapter 111 of the computer 110 of the second node are connected.

When the notification of the network control coordinate program 203 (Step 401) is start processing of the cluster control program 202, that is, at start time when the computer of the cluster node transitions from stop to start, the network control program 242 issues a command to enable the port 120, of the internal network switch 120 and the port 130, of the external network switch 130 to which the computer 100 of the first node being an operation mode transition notification source is connected (Step 404). Conversely, when the computer of the cluster node is stopped, that is, when the cluster control program 202 is stopped, the network control program 242 disable these ports (Step 405). For other transitions such as from execution to wait, and from execution and wait to start, nothing is done (not shown in the flowchart of FIG. 4).

After these processings, the network control program 242 notifies the sending source of the notification of the completion of network configuration change (Step 406).

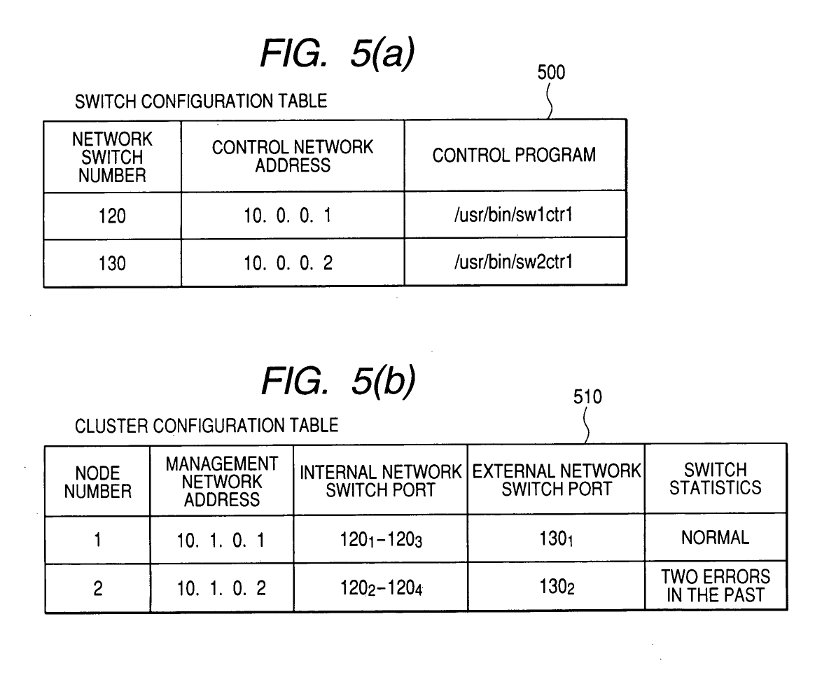

The following describes the structure of data managed in the cluster control computer 140 (data structure of the first embodiment) with reference to FIGS. 5A and 5B. The data structure is stored in a configuration file within the cluster control computer 140 in a format interpretable to programs executed in the cluster control computer 140, and can be referred to by the programs. 500 shown in FIG. 5A designates a switch configuration table. The table 500 manages information of the internal network switch 120 and the external network switch 130 that constitute a network of the cluster. For example, it stores control network addresses indicating sending destinations of requests to change the setting of the internal network switch 120 and the external network switch 130, paths of control programs that perform control of port enabling and disabling and implement acquisition processing of network statistics, and other information.

510 shown in FIG. 5B designates a cluster configuration table. The table 510 manages information about connections between the computers of the nodes of the cluster and the ports of the switches. For example, it manages the internal network switch 120 and numbers of its ports, and the external network switch 130 and numbers of its ports.

The network control program 242 can change the network configuration of the cluster by referring to the tables 500 and 510.

The cluster control computer 140 has a procedure for storing the above-described configuration contents in the table.

The table 510 may contain data relating to records on network statistics acquired previously. This will be described in a second embodiment.

By the above processing, in coordination with operation mode transition of the cluster, the configuration of a network to constitute the cluster can be changed during failover. Thus, a computer of a node that is determined to stop by mutual monitoring can be disconnected from the cluster, and the influence of the computer of the node that fails can be blocked off without fail. Additionally, even when a computer of a party node stops temporarily, both the operation modes of computers of two nodes can be prevented from going into the master state without fail.

### Second Embodiment

In the second embodiment, in addition to the control of the first embodiment, control described below is executed. The network control program 242 executed in the cluster control computer 140 refers to network statistics on transmission and reception of the ports of the internal network switch 120 to constitute a network for mutual monitoring of the node computers, and when communication with a computer of a party node is determined to be interrupted, notifies the cluster control programs 202 and 212 of the fact and requests failover from them. Alternatively, the network control program 242 controls the switch to disable the port connected to the computer of the party node with which communication is determined to be interrupted.

The following describes in detail the second embodiment of the present invention. In the second embodiment, the cluster control computer 140 refers to network statistics on communication states of an internal network collected by the internal network switch 120 to change a network configuration of the cluster, thereby isolating a computer of a node suspected to fail.

Generally, a network switch to constitute a network records network statistics of packet transmission and reception and the like per ports to which computers are connected. The network statistics can be referred to from the outside.

In this embodiment, the network monitor program 241 executed in the cluster control computer 140 acquires network statistics acquired by the internal network switch 120 to constitute an internal network. Specifically, it acquires network statistics of the ports 120, and 120₂ of the internal network switch 120 to which the internal network adapter 103 of the computer 100 of the first node and the internal network adapter 113 of the computer 110 of the second node are respectively connected.

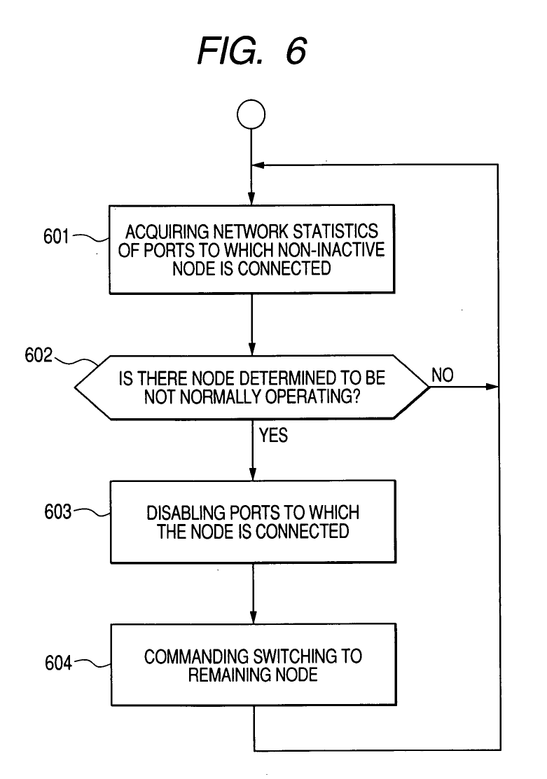

FIG. 6 shows a processing flowchart of the internal network monitor program 241. The internal network monitor program 241 performs the processing of Step 601 or 602 at a fixed cycle. It refers to the switch configuration table 500 and the cluster configuration table 510 and acquires network statistics of the ports of the internal network switch 120 to constitute an internal network (Step 601). Specifically, it refers to the definition of the internal network of the cluster configuration table 510 to obtain a switch concerned and port numbers, and acquires and records the network statistics.

In the table 510 shown in FIG. 5B, the internal network switch ports of the first node are described as 120₁ to 120₃, which means that the first node is connected to the internal network 120 at the first port 120₁ and the third port 120₃ of the internal network switch 120. This means that, in the configuration of FIG. 1, the internal network adapter 103 is connected to the port 120₁ of the internal network switch 120, and the control network adapter 102 is connected to the port 120₃ of the internal network switch 120. Likewise, the internal network switch ports of the second node are described as 120₂ to 120₄, which means that the second node is connected to the internal network 120 at the second port 120₂ and the fourth port 120₄ of the internal network switch 120. On the other hand, the external network switch 130 of the first node is described as 130₁, which means that the first node is connected to an external network at the first node 130₁ of the external network switch 130. This means that, in the configuration of FIG. 1, the external network adapter 101 is connected to the port 130₁ of the external network switch 130. Likewise, the second node is connected to the external network switch 130 at the port 130₂ of the external network switch 130. Furthermore, by referring to the table 500, the address of a management network required to acquire network statistics from the internal network switch 120 and a switch control program can be acquired. In this way, network statistics on ports to constitute the internal network is acquired.

Next, the internal network monitor program 241 determines operating states of the cluster nodes from the acquired network statistics (Step 602). Although conditions of the determination are various, for example, it can be determined that a node stops when data is not sent to the internal network switch 120 from the node for a predetermined period of time or longer.

When there is a node determined to fail, the internal network monitor program 241 disables ports used by the node for connection to the internal network and the external network (Step 603). Also in this case, by referring to the table 510, switches and their port numbers that must be disabled can be acquired. If the operation mode of a node determined to fail is the master state and a party node is the slave state, the cluster control program 202 or 212 of the party node executes failover and shifts the operation mode from the slave state to the master state.

Thus, the internal network of the cluster is configured with the switches and a node determined to fail from network statistics collected from the switches can be isolated from the cluster. By this arrangement, the failing node can be disconnected from the cluster, independently of the cluster control programs 202 and 212 executed in the nodes. For example, even when the operation modes of the nodes cannot be changed due to the cluster control programs or other factors, the nodes can be disconnected and influence on the outside can be reduced.

Additionally, besides disabling the ports to which the computer of the abnormal computer is connected, the cluster control computer 140 may command the computer of the remaining node to perform failover (Step 604). The computer of the commanded node can, if the operation mode at that time is the slave state, activate failover to start transition to the master state. By doing so, failover processing can be started before the cluster control programs of the node computers detect abnormality.

In the second embodiment, although an internal network of the cluster is configured with one internal network switch 120, it may be configured with plural switches. In this case, the node computers may be provided with plural network adapters for connection to the internal network and plural ports may be described in internal ports of the cluster configuration table 510. The network control program 242 enables or disables all ports described in the table 510. The internal network monitor program 241 may acquire network statistics of all internal ports described in the table 510 to determine operating states of the node computers. By doing so, even if one of the internal network switches 120 to constitute the internal network fails, operation as the cluster can be continued.

Although, in the above-described embodiments, the internal network switch 120 and the external network switch 130 are configured as separate ones, it goes without saying that they may be configured as a single network switch.

What is claimed is:

1. A cluster system comprising:
computers to constitute two nodes;
an internal network switch through which the two computers interchange information with each other to respectively monitor the aliveness of the counterpart;
an external network switch for connecting the two computers and client computers that access the two computers to receive service; and
a cluster control computer that is connected to the internal network switch and controls operation modes between master and slave, wherein, in the master, one of the two computers processes requests from the client computer, while in the slave, another computer is waiting to take over processing of the master,
wherein the internal network switch and the external network switch are connected with the computers through ports externally controllable to enable or disable the connection, and
the two computers determine the need for operation mode transition by information interchange via the internal network switch, and the cluster control computer changes the enabling or disabling of ports of the network switches to which the nodes are connected, on receiving notification of the operation mode transition.

2. The cluster system according to claim 1,
wherein when shifting the operation mode of the computer of the node from a slave state to a master state, the cluster control computer disables ports of the internal network switch to which the computer of another node being previously in a master state is connected, and ports of the external network switch to which the computer of the another node is connected to provide service to the client computers.

3. The cluster system according to claim 1,
wherein when shifting the operation mode of the computer of the node from an inactive state to an active state, the cluster control computer enables ports of the internal network switch to which the computer is connected, and ports of the external network switch to which the computer of the another node is connected to provide service to the client computers.

4. The cluster system according to claim 1,
wherein when shifting the operation mode of the computer of the node to an inactive state, the cluster control computer disables ports of the internal network switch to which the computer is connected, and ports of the external network switch to which the computer of the another node is connected to provide service to the client computers.

5. The cluster system according to claim 1,
wherein the cluster control computer collects data on the enabling and disabling of ports of the internal network switch, determines the need for operation mode transition of the computers connected to the internal network switch by referring to the data, and on receiving notification of the operation mode transition, changes the enabling or disabling of ports of the network switches to which the nodes are connected.
